(19) United States
(12) Patent Application Publication
(10) Pub. No.: US 2025/0157337 A1
(43) Pub. Date: May 15, 2025

(54) COMPUTER SYSTEM AND METHOD FOR TURN INDICATOR CANCELLATION

(71) Applicant: Volvo Truck Corporation, Göteborg (SE)

(72) Inventors: Remi BARRELLON, SIMANDRES (FR); Oriana GONZALEZ MOSQUERA, LYON (FR); David DE BRITO, CHARVIEU CHAVAGNEUX (FR)

(21) Appl. No.: 18/928,837

(22) Filed: Oct. 28, 2024

(30) Foreign Application Priority Data
Nov. 15, 2023 (EP) 23210168.3

(51) Int. Cl. G08G 1/16; B60Q 1/40

(52) U.S. Cl. CPC G08G 1/167; B60Q 1/40

(57) ABSTRACT

A computer system is provided, comprising processing circuitry configured to: determine that a turn indicator of a host vehicle is activated; obtain a cross-over distance between the host vehicle and a cross-over lane line during a lane change from an original lane over the cross-over lane line to a target lane; determine that the cross-over distance is at least as great as a predetermined distance; and cancel the turn indicator.

### PRIORITY APPLICATIONS

The present application claims priority to European Patent Application No. 23210168.3, filed on Nov. 15, 2023, and entitled “COMPUTER SYSTEM AND METHOD FOR TURN INDICATOR CANCELLATION,” which is incorporated herein by reference in its entirety.

### TECHNICAL FIELD

The disclosure relates generally to vehicles. In particular aspects, the disclosure relates to a computer system and a method for turn indicator cancellation. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Vehicles are normally equipped with turn indicators, and modern vehicles are often configured to implement automatic cancellation of the turn indicator when the turn is completed and the steering wheel angle returns to its normal position.

It is important to use the turn indicator not only to indicate a turn, but also to indicate a lane change. Especially during highway driving, the motion of the steering wheel angle during a change of lane is too small to be used for automatic turn indicator cancellation. In view of this, there is a need for improvements.

### SUMMARY

According to a first aspect of the disclosure, a computer system is provided. The computer system comprises processing circuitry configured to determine that a turn indicator of a host vehicle is activated, obtain a cross-over distance between the host vehicle and a cross-over lane line during a lane change from an original lane over the cross-over lane line to a target line, determine that the cross-over distance is at least as great as a predetermined distance, and cancel the turn indicator. The first aspect of the disclosure may seek to enable automatic turn indicator cancellation during lane change and in situations where the turn indicator is activated, but when the steering wheel angle is insufficient to be used as a cancellation parameter. A technical benefit may include improving traffic safety and assistance during driving.

Optionally in some examples, including in at least one preferred example, the cross-over distance between the host vehicle and the cross-over lane line is a lateral distance extending in a direction being perpendicular to the longitudinal direction of the cross-over lane line. A technical benefit may include a more robust cancellation of the turn indicator also in situations when lane change occurs in a curve, which otherwise could affect the obtained value of the cross-over distance.

Optionally in some examples, including in at least one preferred example, the cross-over distance between the host vehicle and the cross-over lane line is a distance between a center of the host vehicle and the cross-over lane line. A technical benefit may include a consistent obtaining of the cross-over distance for lane changes to the left as well as to the right.

Optionally in some examples, including in at least one preferred example, the processing circuitry is configured to obtain the cross-over distance between the host vehicle and the cross-over lane line by measuring the cross-over distance between the host vehicle and the cross-over lane line. A technical benefit may include a simple obtaining of the cross-over distance.

Optionally in some examples, including in at least one preferred example, the processing circuitry is configured to obtain the cross-over distance between the host vehicle and the cross-over lane line by measuring a margin distance between the host vehicle and a distant lane line of the target lane. A technical benefit may include a more versatile obtaining of the cross-over distance, especially beneficial in situations when the cross-over lane is non-detectable.

Optionally in some examples, including in at least one preferred example, the processing circuitry is further configured to measure the margin distance between the host vehicle and a distant lane line of the target lane as a response to a failed attempt to measure the cross-over distance between the host vehicle and the cross-over lane line. A technical benefit may include a more robust and still efficient obtaining of the cross-over distance that is capable of handling also situations when the cross-over lane is non-detectable.

Optionally in some examples, including in at least one preferred example, the cross-over distance is obtained by subtracting the measured margin distance from a target lane width. A technical benefit may include a simple determining of an occurred lane change even when it is not possible to determine the true cross-over distance.

Optionally in some examples, including in at least one preferred example, the predetermined distance is a fixed value. A technical benefit may include a very simple and fast process for determining a lane change.

Optionally in some examples, including in at least one preferred example, the predetermined distance is based on a width of at least one of the original lane and the target lane. A technical benefit may include improved timing of the turn indicator cancellation.

Optionally in some examples, including in at least one preferred example, the processing circuitry is further configured to obtain a change in distance between the host vehicle and a lane line during a lane change from an original lane over the cross-over lane to a target lane; determine that the change in distance is at least as great as a predetermined change in distance; and cancel the turn indicator based on the change in distance being at least as great as the predetermined change in distance. A technical benefit may include improving robustness of the turn indicator cancellation in situations where it is not possible to accurately determine the cross-over distance.

Optionally in some examples, including in at least one preferred example, the change in distance represents a change of lane line from a left lane line of the original lane to a left lane line of the target lane, or from a right lane line of the original lane to a right lane line of the target lane. A technical benefit may include a versatile approach for lane changes to the left as well as for lane changes to the right.

Optionally in some examples, including in at least one preferred example, the processing circuitry is further configured to determine that a distance between the vehicle and the left or right lane line is within a tolerance interval based on the obtained change in distance. A technical benefit may include verifying that the lane change has occurred before cancelling the turn indicator.

Optionally in some examples, including in at least one preferred example, the cross-over distance between the host vehicle and the cross-over lane line is a lateral distance extending in a direction being perpendicular to the longitudinal direction of the cross-over lane line, and wherein the cross-over distance between the host vehicle and the cross-over lane line is a distance between a center of the host vehicle and the cross-over lane line. The processing circuitry is further configured to: obtain the cross-over distance between the host vehicle and the cross-over lane line by measuring the cross-over distance between the host vehicle and the cross-over lane line and/or obtain the cross-over distance between the host vehicle and the cross-over lane line by measuring a margin distance between the host vehicle and a distant lane line of the target lane; and to measure the margin distance between the host vehicle and a distant lane line of the target lane as a response to a failed attempt to measure the cross-over distance between the host vehicle and the cross-over lane line, wherein the cross-over distance is obtained by subtracting the measured margin distance from a target lane width. The predetermined distance is a fixed value or the predetermined value is based on a width of at least one of the original lane and the target lane. The processing circuitry is further configured to: obtain a change in distance between the host vehicle and a lane line during a lane change from an original lane over the cross-over lane to a target lane; and determine that the change in distance is at least as great as a predetermined change in distance, and cancel the turn indicator based on the change in distance being at least as great as the predetermined change in distance, wherein the change in distance represents a change of lane line from a left lane line of the original lane to a left lane line of the target lane, or from a right lane line of the original lane to a right lane line of the target lane. The processing circuitry is further configured to: determine that a distance between the vehicle and the left or right lane line is within a tolerance interval based on the obtained change in distance, and the processing circuitry is further configured to: re-determine, for a subsequent position of the host vehicle during the lane change, that the distance between the vehicle and the left or right lane line is within the tolerance interval. A technical benefit may include a further verification of the occurred lane change.

According to a second aspect of the disclosure, a vehicle is provided. The vehicle comprises the computer system of the first aspect.

According to a third aspect of the disclosure, a computer-implemented method is provided. The computer-implemented method comprises: determining, by processing circuitry of a computer system, that a turn indicator of a host vehicle is activated; obtaining, by the processing circuitry, a cross-over distance between the host vehicle and a cross-over lane line during a lane change from an original lane over the cross-over lane line to a target lane; determining, by the processing circuitry, that the cross-over distance is at least as great as a predetermined distance, and cancelling, by the processing circuitry, the turn indicator. The third aspect of the disclosure may seek to enable automatic turn indicator cancellation during lane change and in situations where the turn indicator is activated, but when the steering wheel angle is insufficient to be used as a cancellation parameter. A technical benefit may include improving traffic safety and assistance during driving.

Optionally in some examples, including in at least one preferred example, the method further comprises: obtaining, by the processing circuitry, the cross-over distance between the host vehicle and the cross-over lane line by measuring the cross-over distance between the host vehicle and the cross-over lane line, or by measuring a margin distance between the host vehicle and a distant lane line of the target lane. A technical benefit may include a very simple obtaining of the cross-over distance, as well as a more versatile obtaining of the cross-over distance, especially beneficial in situations when the cross-over lane is non-detectable.

Optionally in some examples, including in at least one preferred example, the method further comprises: measuring the margin distance between the host vehicle and a distant lane line of the target lane as a response to a failed attempt to measure the cross-over distance between the host vehicle and the cross-over lane line. A technical benefit may include a more robust and still efficient obtaining of the cross-over distance that is capable of handling also situations when the cross-over lane is non-detectable.

Optionally in some examples, including in at least one preferred example, the cross-over distance is obtained by subtracting the measured margin distance from a target lane width. A technical benefit may include a simple determining of an occurred lane change even when it is not possible to determine the true cross-over distance.

According to a fourth aspect of the disclosure, a computer program product is provided. The computer program product comprises program code for performing, when executed by the processing circuitry, the method of the third aspect.

According to a fifth aspect of the disclosure, a non-transitory computer-readable storage medium is provided. The non-transitory computer-readable storage medium comprises instructions, which when executed by the processing circuitry, cause the processing circuitry to perform the method of the third aspect.

According to a further aspect of the disclosure, a computer system is provided. The computer system comprises processing circuitry configured to obtain a change in distance between the host vehicle and a lane line during a lane change from an original lane over the cross-over lane to a target lane; determine that the change in distance is at least as great as a predetermined change in distance; and cancel the turn indicator based on the change in distance being at least as great as the predetermined change in distance. A technical benefit may include improving robustness of the turn indicator cancellation in situations where it is not possible to accurately determine the cross-over distance.

Optionally in some examples, including in at least one preferred example, the processing circuitry is further configured to determine that a distance between the vehicle and a left or right lane line is above a predetermined threshold before the change in distance is obtained.

Optionally in some examples, including in at least one preferred example, the processing circuitry is further configured to verify the lane change before the turn indicator is cancelled.

According to a further aspect of the disclosure, a method is provided. The method comprises obtaining a change in distance between the host vehicle and a lane line during a lane change from an original lane over the cross-over lane to a target lane; determining that the change in distance is at least as great as a predetermined change in distance; and cancelling the turn indicator based on the change in distance being at least as great as the predetermined change in distance.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

FIG. 1 is an exemplary view of a vehicle according to an example.

FIG. 2 is an exemplary view of a vehicle during a lane change according to an example.

FIG. 3 is an exemplary diagram of a turn indicator cancellation system according to different examples.

FIG. 4A is a schematic diagram of the positions of a vehicle during a lane change from, with reference to the driving direction, a left lane to a right lane according to an example.

FIG. 4B is a schematic diagram of the positions of a vehicle during a lane change from a right lane to a left lane according to an example.

FIG. 4C is a schematic diagram of the positions of a vehicle during a lane change from a right lane to a left lane according to an example.

FIG. 4D is a schematic diagram of the positions of a vehicle during a lane change from a right lane to a left lane according to an example.

FIG. 5 is a flow chart of an exemplary method to cancel the turn indicator of a vehicle after a lane change according to an example.

FIG. 6 is a flow chart of an exemplary method to cancel the turn indicator of a vehicle after a lane change according to an example.

FIG. 7 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The examples presented herein provide a solution to improve automatic cancellation of a turn indicator of a vehicle, in particular a heavy duty vehicle such as a truck, a bus, etc. While existing turn indicator cancellation solutions typically rely on the steering wheel angle, the herein described examples allow for automatic turn indicator cancellation even in situations where the change in steering wheel angle is insignificant, i.e. during lane changes. By identifying a cross-over distance, i.e. the distance between the vehicle and the cross-over lane line, to be at least as great as a predetermined distance, it is possible to accurately determine that a lane change has occurred and that the turn indicator should be turned off.

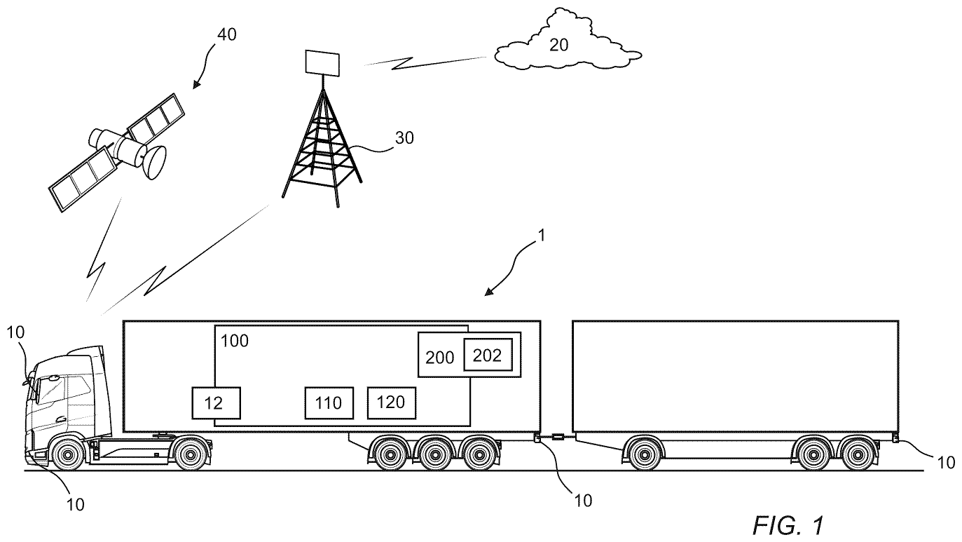

FIG. 1 is an exemplary view of a vehicle 1 according to one example. The vehicle 1 comprises one or more turn indicators 10, and the vehicle 1 is programmed to cancel the one or more turn indicators 10 automatically after a lane change, as will be described further in the following. The one or more turn indicators 10 are preferably provided as one or more blinkers, or light emitting devices, arranged at front, rear, and possible intermediate positions on both left and right sides of the vehicle 1 and configured to provide a blinking signal for the surrounding traffic. Preferably, as is well known in the art, the turn indicators 10 are synchronized in terms of initiation and cancellation.

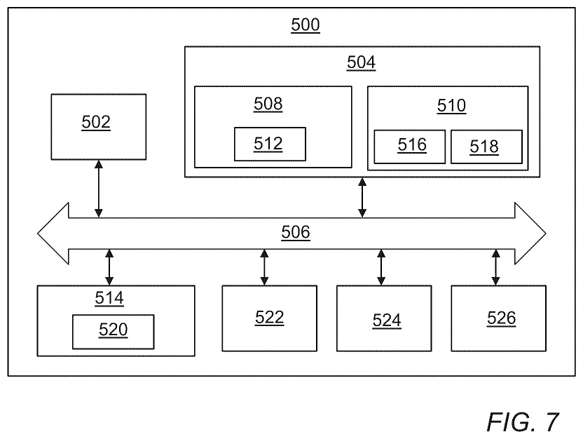

The vehicle 1 comprises, at least to some extent, processing circuitry 110 forming part of a computer system 100 (see FIG. 7). The processing circuitry 110 is configured to implement a turn indicator cancellation system 200.

The vehicle 1 may further comprise communications circuitry 12 configured to receive and/or send communications. The communications circuitry 12 may be configured to enable the vehicle 1 to communicate with one or more external devices or systems such as a cloud server 20. The communication with the external devices or systems may be directly or via a communications interface such as a cellular communications interface 30, such as a radio base station. The cloud server 20 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 12 may, additionally or alternatively, be configured to enable the vehicle 1 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 1 may for example be configured to utilize data obtain from the GNSS 40 to determine a geographical location of the vehicle 1.

The vehicle 1 in FIG. 1 comprises the computer system 100 and the turn indicator cancellation system 200. The computer system 100 may be operatively connected to the turn indicator cancellation system 200 and optionally to the communications circuitry 12 of the host vehicle 1. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The turn indicator cancellation system 200 may comprise turn indicator cancellation system processing circuitry 202; the turn indicator cancellation system processing circuitry 202 may be part of the processing circuitry 110 of the computer system 100.

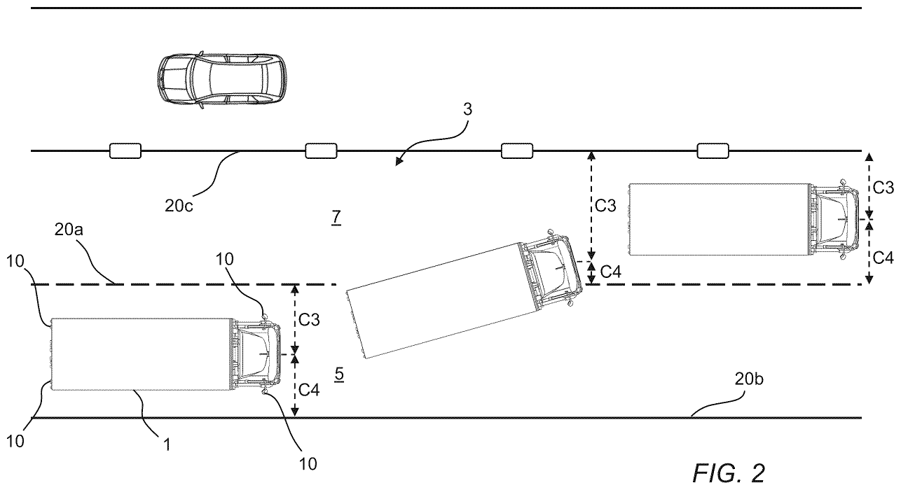

In FIG. 2 operation of the vehicle 1 is shown schematically, as the vehicle 1 traverses a road segment 3 having an inner lane 5 and an outer lane 7. The lanes are indicated by lane lines 20a-c. The lane lines 20 may be solid or dashed. Starting at the left side of the drawing, the vehicle 1 initiates a lane change from the original inner lane 5 by turning on the turn indicators 10. Such activation of the turn indicators 10 may be performed by a driver maneuvering a stalk, by pushing a button, or similar.

The turn indicators 10 are turned on as the vehicle 1 crosses the cross-over lane line 20a, i.e. the lane line separating the inner lane 5 from the outer lane 7, as indicated by the central portion of the drawing.

When the vehicle 1 has successfully performed the lane change, as indicated by the right portion of the drawing, the turn indicators 10 are automatically cancelled, i.e. turned off. This cancellation of the turn indicators 10 is effected by the turn indicator cancellation system 200 of the vehicle 1.

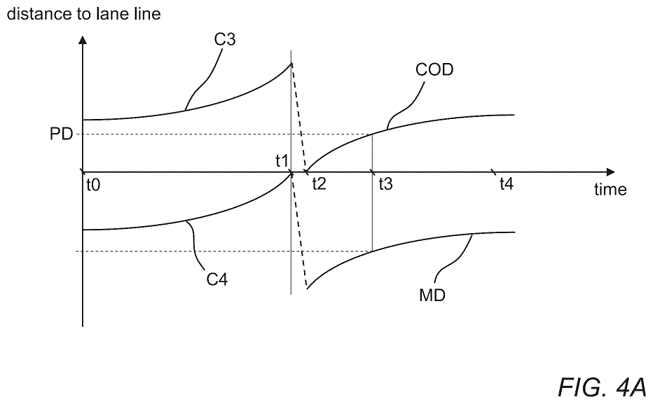

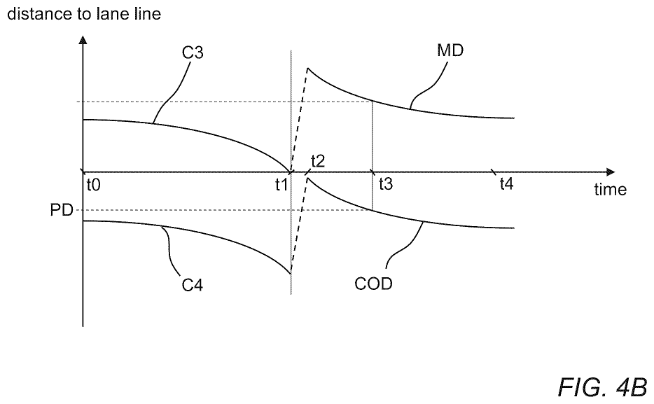

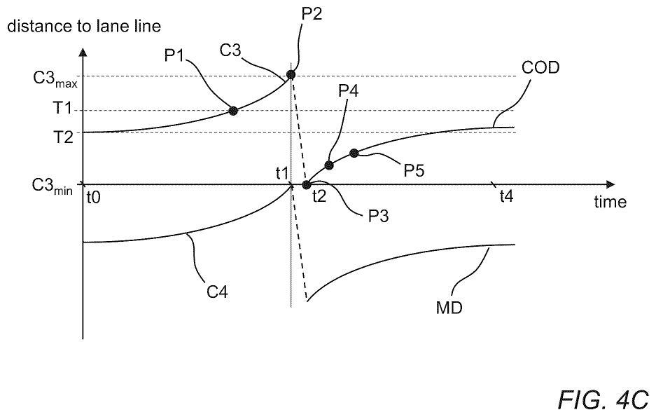

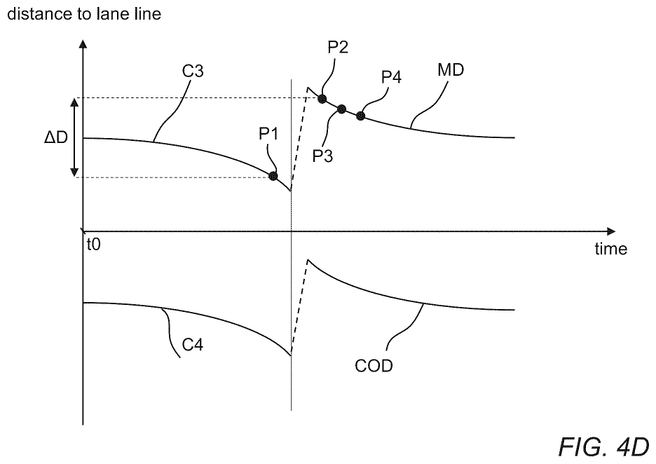

The turn indicator cancellation system 200 operates based on obtained distances between the vehicle 1 and the immediate left and right lane lines 20a-c. These obtained distances, which will be explained further in particular with reference to FIGS. 4A-D, are in FIG. 2 indicated by reference numerals C3, C4. The distance C3 represents the lateral distance between the vehicle 1 and the immediate left lane line. As is shown in FIG. 2, the left lane line is initially the cross-over lane line 20a, but changes to the distant left lane line 20c when the cross-over lane line 20a has been passed. The distance C4 represents the lateral distance between the vehicle 1 and the immediate right lane line. As is shown in FIG. 2, the right lane line is initially the distant right lane line 20b, but changes to the cross-over lane line 20a when the cross-over lane line 20a has been passed.

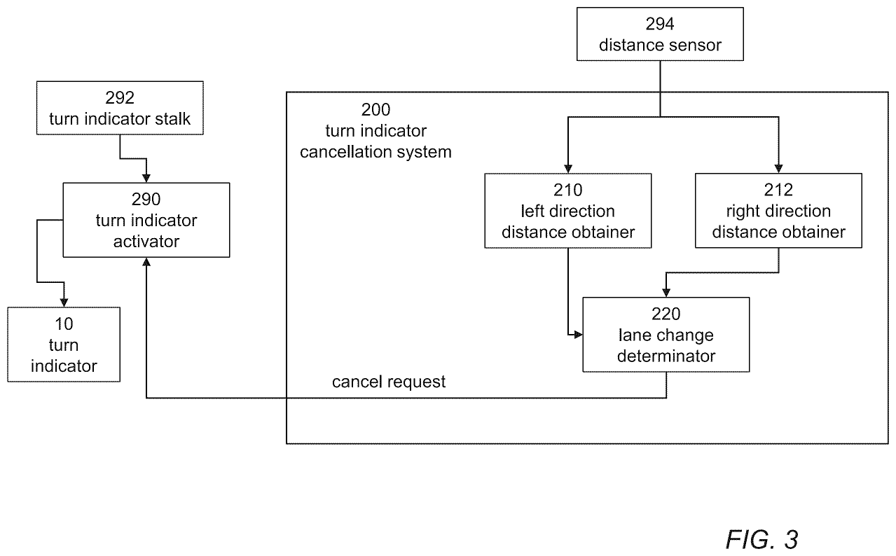

An example of a turn indicator cancellation system 200 is shown in FIG. 3. The turn indicator cancellation system 200 operates in conjunction with a turn indicator activator 290 which may or may not form part of the turn indicator cancellation system 200. The turn indicator activator 290 is programmed to turn on one or more turn indicators 10 of the vehicle 1 in response to a start signal generated by a turn indicator stalk 292.

The turn indicator cancellation system 200 is further programmed to operate in conjunction with a distance sensor 294. The distance sensor 294 may or may not form part of the turn indicator cancellation system 200. The distance sensor 294 is preferably in the form of one or more cameras arranged at the front center of the vehicle 1 and associated image analysis software and/or hardware configured to extract distance information from the captured images. Preferably, the one or more cameras 294 have a field view covering both left and right sides of the area in front of the vehicle 1 such that lane lines 20a-c are within the field view of the one or more cameras 294.

The turn indicator cancellation system 200 comprises a first distance obtainer 210 and a second distance obtainer 212. The first and second distance obtainers 210, 212 receives data from the distance sensor 294. The first and second distance obtainers 210, 212 may be incorporated as a single distance obtainer. Based on the received data, the first distance obtainer 210 is configured to obtain a distance from the vehicle 1 to a lane line 20a-c arranged immediately to the left of the vehicle 1. Based on the received data, the second distance obtainer 212 is configured to obtain a distance from the vehicle 1 to a lane line 20a-c arranged immediately to the right of the vehicle 1. With reference to FIG. 2, before the lane change the first distance obtainer 210 is configured to obtain the distance from the vehicle 1 to the cross-over lane line 20a, while the second distance obtainer 212 is configured to obtain the distance from the vehicle 1 to the outer lane line 20b. Once the cross-over lane line 20a is crossed by the vehicle 1, i.e. after the lane change the first distance obtainer 210 is configured to obtain the distance from the vehicle 1 to the inner lane line 20c, while the second distance obtainer 212 is configured to obtain the distance from the vehicle 1 to the cross-over lane line 20a.

The turn indicator cancellation system 200 further comprises a lane change determinator 220. The lane change determinator 220 receives data from at least one of the first and second distance obtainers 210, 212. Based on the received data, i.e. information of the distance between the vehicle 1 and the immediately adjacent lane line 20a-c, the lane change determinator 220 is programmed to determine that a lane change is performed. Upon such determination, which will be further explained with reference to FIGS. 4A-B, the turn indicator cancellation system 200 is programmed to issue and transmit a cancellation request to the turn indicator activator 290 which immediately turns off the one or more turn indicators 10.

FIG. 4A shows a diagram of the positions of a vehicle 1 during a lane change from a left lane to a right lane. With reference to FIG. 2, the situation shown in FIG. 4A would represent the vehicle 1 returning from the outer lane 7 to the inner lane 5. The upper curve C3 represents the distance between the vehicle 1 and the left lane line (i.e. the lane line immediately to the left of the vehicle 1) as a positive value, and the bottom curve C4 represents the distance between the vehicle 1 and the right lane line (i.e. the lane line immediately to the right of the vehicle 1) as a negative value. It should be noted that the distance between the vehicle 1 and the lane lines could be any distance measured from the vehicle 1, such as the distance measured from the outermost edge of the vehicle 1, i.e. the left and right edges, respectively, or from a center position of the vehicle 1.

Initially, at time t0, the vehicle 1 is positioned centrally at the original left lane 7. The absolute value of the C3 curve is approximately the same as the absolute value of the C4 curve. As the vehicle 1 starts to move to the right, approaching the inner lane 5, the distance to the left lane line 20c increases as represented by the C3 curve. At the same time the distance to the right lane line 20a, represented by the absolute value of the C4 curve, decreases. At time t1 the vehicle 1 is positioned at the cross-over lane line 20a, meaning that the distance to the left lane line 20c reaches its maximum value (the C3 curve) while the distance to the right lane line, i.e. the cross-over line 20a, is approximately zero.

At time t2 the vehicle 1 has moved further to the right, meaning that the cross-over lane line 20a is detectable as the left lane line immediately adjacent to the vehicle 1. As a response to this shift of which lane line being the left lane line, the C3 curve exhibits a rapid jump indicated by the dashed line. As soon as the cross-over lane line 20a is crossed, the distance to the left lane line 20a is approximately zero.

The C4 curve exhibits a similar jump at time t2. When the cross-over lane line 20a is crossed, it will no longer be detectable as the right lane line but instead the detectable right lane line will be the right-most lane line 20c of the inner lane 5. The distance to this distant lane line 20c will, at time t2, be at a maximum as represented by the absolute value of the C4 curve.

As the vehicle 1 continues its positioning to the right, towards the center of the right lane 5, it will eventually be centrally positioned as indicated at time t4. Before this happens, at time t3 it is determined that the lane change is finished. This is concluded by comparing the value of the C3 curve, representing the cross-over distance COD, with a predetermined distance PD. When the cross-over distance COD is at least as great as the predetermined distance PD, which for example may be set to 1 m, it is determined that the lane change is finished.

Optionally, the cross-over distance COD may be determined from the C4 curve. The C4 curve does not directly represent the cross-over distance COD, but rather a margin distance MD from the vehicle 1 to the distant lane line 20b. However, the cross-over distance COD can be calculated from the margin distance MD by the equation:

$$COD = lane width - MD .$$

This means that by knowing the lane width the cross-over distance COD can be easily obtained from the measured margin distance MD. The lane width may be measured during driving by the distance sensor 294 and suitable image analysis software and/or hardware, or the lane width may be estimated as a standard lane width. The estimation of the lane width may be based on several parameters including map data, vehicle speed, etc.

FIG. 4B shows the position of the vehicle 1 when performing a lane change, going from a right lane 5 to a left line 7. This corresponds to the lane change illustrated in FIG. 2.

The upper curve C3 represents the distance between the vehicle 1 and the left lane line (i.e. the cross-over lane line 20a immediately to the left of the vehicle 1) as a positive value, and the bottom curve C4 represents the distance between the vehicle 1 and the right lane line (i.e. the distant lane line 20c immediately to the right of the vehicle 1) as a negative value.

Initially, at time t0, the vehicle 1 is positioned centrally at the original right lane 5. The absolute value of the C3 curve is approximately the same as the absolute value of the C4 curve. As the vehicle 1 starts to move to the left, approaching the outer lane 7, the distance to the cross-over line 20a decreases as represented by the C3 curve. At the same time the distance to the distant right lane line 20c, represented by the absolute value of the C4 curve, increases. At time t1 the vehicle 1 is positioned at the cross-over lane line 20a, meaning that the distance to the cross-over lane line 20a reaches its minimum value (the C3 curve) while the distance to the distant right lane line 20c reaches its maximum value.

At time t2 the vehicle 1 has moved further to the left, meaning that the distant left lane line 20b of the target outer lane 7 is detectable as the left lane line immediately adjacent to the vehicle 1. As a response to this shift of which lane line being the left lane line, the C3 curve exhibits a rapid jump indicated by the dashed line. As soon as the cross-over lane line 20a is crossed, the distance to the new left lane line 20b is at a maximum.

The C4 curve exhibits a similar jump at time t2. When the cross-over lane line 20a is crossed, it will be detectable as the right lane line thus replacing the previously detectable distant lane line 20b of the original inner lane 5. The distance to the cross-over lane line 20a will, at time t2, be approximately zero as represented by the absolute value of the C4 curve.

As the vehicle 1 continues its positioning to the left, towards the center of the left lane 7, it will eventually be centrally positioned as indicated at time t4. Before this happens, at time t3 it is determined that the lane change is finished. This is concluded by comparing the absolute value of the C4 curve, representing the cross-over distance COD, with a predetermined distance PD. When the cross-over distance COD is at least as great as the predetermined distance PD, which for example may be set to 1 m, it is determined that the lane change is finished.

Optionally, the cross-over distance COD may be determined from the C3 curve. The C3 curve does not directly represent the cross-over distance COD, but rather a margin distance MD from the vehicle 1 to the distant lane line 20c. In order to determine that the predetermined distance PD is reached, the cross-over distance COD can be calculated from the margin distance MD.

Hence, the distance to the lane lines are provided by the C3 curve and the C4 curve. For a lane change to the right, the C3 curve will directly correspond to the cross-over distance COD while the C4 curve indirectly corresponds to the cross-over distance COD by means of the margin distance MD and the lane width. For a lane change to the left, the C4 curve will directly correspond to the cross-over distance COD while the C3 curve indirectly corresponds to the cross-over distance COD by means of the margin distance MD and the lane width.

Based on the description of FIGS. 4A-B, the information provided by the C3 curve and the C4 curve allows for accurately determining that a lane change has occurred, whereby the turn indicator 10 can be cancelled without any input relating to the steering wheel angle of the vehicle 1.

For example, direct determination of the cross-over distance COD may be preferred and indirect determination via the margin distance MD may only be performed if the cross-over distance COD cannot be directly determined. This may occur for example if the cross-over lane line 20a is vague or partially missing, or if there is some data loss from the distance sensor 294.

In FIG. 4C another example for determining a lane change is shown, which forms the basis for the turn indicator cancellation system 200. The lane change is the same as shown in FIG. 4A, i.e. a lane change from a left lane to a right lane. Accordingly, the C3 curve represents the cross-over distance COD once the cross-over lane line 20a has been crossed, while the C4 curve represents the margin distance MD to the distant left lane line 20C. While this example will be described with reference to the C3 curve, it should be evident that the same principle could be used for the C4 curve.

As indicated in FIG. 4C, a lane change is determined by sampling the C3 curve and by initially detecting that the C3 value, i.e. the distance between the vehicle 1 and the distant left lane line, is at least as great as a predetermined threshold T1. The predetermined threshold T1 may e.g. be set as a fixed value in the range of 2 m to 3 m, such as between 2.5 m and 2.7 m. This is indicated by sampling point P1. Subsequently, the C3 curve exhibits a jump from a maximum value C3ₘₐₓ, obtained at sample point P2, to a minimum value C3ₘᵢₙ, obtained at sample point P3. This detected jump indicates that the cross-over lane line 20a has been passed by the vehicle 1. The lane change is verified by at least one, but preferably two subsequent samples at sample points P4 and at P5. The distance values obtained at these sampling points P4, P5 are compared with a second threshold T2. The second threshold T2 may be a fixed value in the range of 0.5 m to 1.5 m, such as 1 m. If it is determined that the cross-over distance COD, i.e. the distance given by sample points P4 and P5 on the C3 curve is below the second threshold T2, it is determined that the lane change has occurred satisfactory and that the turn indicator 10 can be turned off or cancelled.

In FIG. 4D another example for determining that a lane change has occurred is shown. The lane change is the same as shown in FIG. 4B, i.e. a lane change from a right lane to a left lane. Accordingly, the C4 curve represents the cross-over distance COD once the cross-over lane line 20a has been crossed, while the C3 curve represents the margin distance MD to the distant left lane line 20C.

As indicated in FIG. 4D and sharing the same basic principle as described with reference to FIG. 4C, a lane change is determined by detecting a jump in any of the curves. While sampling points are shown on the C3 curve, it should be readily understood that these samplings could equally well be made from the C4 curve. By continuously calculating the distance difference ΔD between two adjacent samples, eventually the jump between lane lines will cause a rapid increase of the distance difference ΔD, as indicated in FIG. 4D between sample points P1 and P2. The distance difference ΔD is compared with a predetermined change in distance, which for example may be set to a value between 1.5 m and 2 m. Once this difference in distance ΔD is confirmed to be at least as great as the predetermined change in distance, a lane change is assumed to occur.

The example shown in FIG. 4D is particularly advantageous in situations where the raw data curve is offset, i.e. sample points P1 and P2 will remain at the extreme sampling points but the entire C3 curve is offset positively with regards to the y axis, while the entire C4 is offset negatively on the y axis.

The lane change may be further verified by subsequent samples, indicated by sampling points P3 and P4. The distance values of these sampling points P3, P4, representing the margin distance MD, are compared with a tolerance interval defined by the distance value of the previous sampling point P2. For example, the tolerance interval may be ±50%, more preferably ±40% of the determined difference in distance ΔD of the detected jump. Once the lane change has been confirmed by samples P3 and P4, it is determined that the lane change has occurred satisfactory and that the turn indicator 10 can be turned off or cancelled.

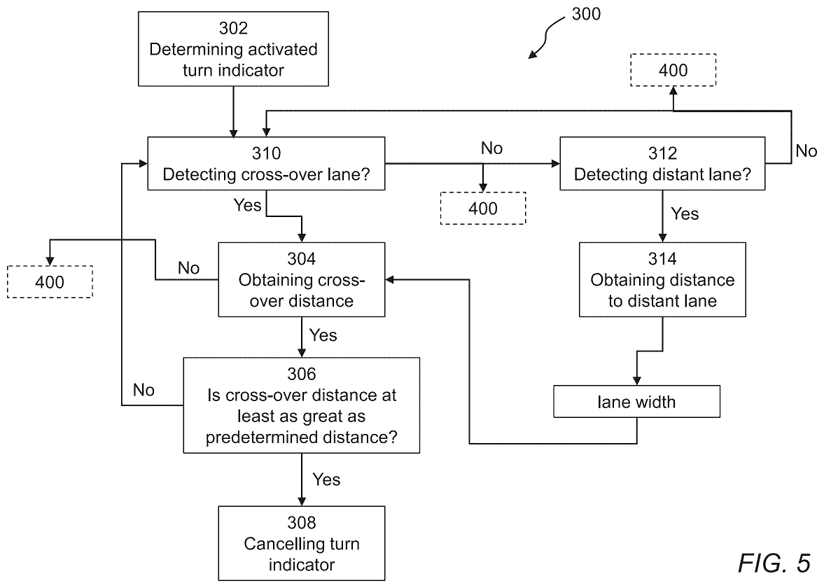

FIG. 5 is a flow chart of a method 300 to automatically cancel a turn indicator 10 according to an example. The method 300 comprises determining 302, by processing circuitry of a computer system, that a turn indicator 10 of a host vehicle 1 is activated. The method 300 further comprises obtaining 304, by the processing circuitry, a cross-over distance COD between the host vehicle 1 and a cross-over lane line 20a during a lane change from an original lane 5, 7 over the cross-over lane line to a target lane 5, 7. The method 300 further comprises determining 306, by the processing circuitry, that the cross-over distance COD is at least as great as a predetermined distance PD, and cancelling 308, by the processing circuitry, the turn indicator 10.

Determining 304 the cross-over distance COD may be performed as shown in FIG. 5. Initially, it is checked 310 if the cross-over lane 20a is detectable. If yes, the distance to the cross-over lane 20a is directly determined 304. If not, the method 300 is checking 312 if the distant lane line is detectable. If not, the method 300 may return to checking 310 if the cross-over lane is detectable. If yes, the method 300 obtains 314 the distance MD between the vehicle 1 and the distant lane line. The distance MD is used, together with the lane width, to obtain the cross-over distance COD.

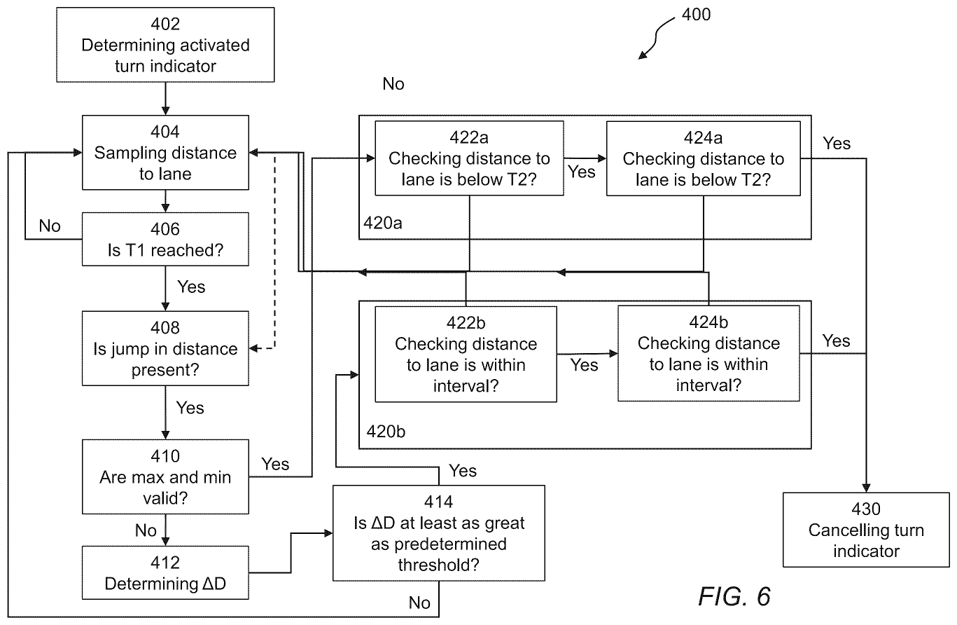

Another example of a method 400 to automatically cancel a turn indicator 10 is shown in FIG. 6. The method 400 could be performed individually and separate without any combination with the method 300 described with reference to FIG. 5. Optionally, the method 400 is performed in combination with the method 300 of FIG. 5 such that the method 400 of FIG. 6 is performed as a response to the method 300 not being able to obtain the cross-over distance COD properly. This is indicated by the dashed boxes representing optional routes in FIG. 5.

Initially, the method 400 determines 402 that the turn indicator 10 is activated. If performed in combination with the method 300, this step 402 may be omitted. Subsequently, the method obtains 404 the distance to the left and/or right lane line, i.e. the current value of any (or both) of the C3 or C4 curves. The method 400 repeats sampling 404 of the distance to the lane line, and eventually determines 406 that the value of the C3 curve and/or C4 curve is at least as great as a first threshold T1. If yes, the method 400 proceeds sampling of the distance to the lane line until it is determined 408 that any of the C3 curve or the C4 curve exhibits a jump, corresponding to crossing of the cross-over lane 20a. If no, the method 400 may in any case proceed sampling of the distance to the lane line according to the dashed line until it is determined 408 that any of the C3 curve or the C4 curve exhibits a jump, corresponding to crossing of the cross-over lane 20a.

The method 400 checks 410 if the obtained maximum and minimum values of the jump are valid, i.e. if they are reasonable with regards to the lane width or if there is an offset present. If they are, the method 400 assumes a performed lane change, and proceeds with a verification procedure 420a. If the obtained maximum and minimum values of the jump are not valid, the method 400 determines 412 the difference in distance ΔD across the jump. In 414 the method 400 determines that the difference in distance ΔD is at least as great as a predetermined difference in distance. Such determination 414 is followed by a verification procedure 420b.

Referring to the verification procedure 420a, which is performed when the jump has been confirmed by valid maximum and minimum values, the method 400 performs a first sampling 422a of the relevant distance between the vehicle 1 and the lane line, i.e. the cross-over distance COD or the margin distance MD. If the distance does not exceed a second threshold T2, a second sampling 424a is made before the turn indicator 10 is cancelled 430. On the other hand, if any of the samplings 422a, 424a does exceed the second threshold T2, the lane change is not confirmed and the method 400 will return to its start position 402.

Referring to the verification procedure 420b, which is performed when the jump has been confirmed by a sufficient distance difference ΔD, the method 400 performs a first sampling 422b of the relevant distance between the vehicle 1 and the lane line, i.e. the cross-over distance COD or the margin distance MD. If the distance lies within a tolerance interval defined by the distance difference ΔD, a second sampling 424b and associated comparison with the tolerance interval is performed before the turn indicator 10 is cancelled 430. On the other hand, if any of the samplings 422b, 424b does not fall within the tolerance interval, the lane change is not confirmed and the method 400 will return to its start position 402.

FIG. 7 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry configured to: determine that a turn indicator (10) of a host vehicle (1) is activated; obtain a cross-over distance (COD) between the host vehicle (1) and a cross-over lane line (20a) during a lane change from an original lane (5, 7) over the cross-over lane line to a target lane (5, 7); determine that the cross-over distance (COD) is at least as great as a predetermined distance (PD); and cancel the turn indicator (10).

Example 2: The computer system of Example 1, wherein the cross-over distance (COD) between the host vehicle (1) and the cross-over lane line (20a) is a lateral distance extending in a direction being perpendicular to the longitudinal direction of the cross-over lane line (20a).

Example 3: The computer system of Example 1 or 2, wherein the cross-over distance (COD) between the host vehicle (1) and the cross-over lane line (20a) is a distance between a center of the host vehicle (1) and the cross-over lane line (20a).

Example 4: The computer system of any of the preceding Examples, wherein the processing circuitry is configured to: obtain the cross-over distance (COD) between the host vehicle (1) and the cross-over lane line (20a) by measuring the cross-over distance (COD) between the host vehicle (1) and the cross-over lane line (20a).

Example 5: The computer system of any of Examples 1 to 3, wherein the processing circuitry is configured to: obtain the cross-over distance (COD) between the host vehicle (1) and the cross-over lane line (20a) by measuring a margin distance (MD) between the host vehicle (1) and a distant lane line (20b, 20c) of the target lane (5, 7).

Example 6: The computer system of Example 5, wherein the processing circuitry is further configured to: measure the margin distance (MD) between the host vehicle (1) and a distant lane line (20b, 20c) of the target lane (5, 7) as a response to a failed attempt to measure the cross-over distance (COD) between the host vehicle (1) and the cross-over lane line (20a).

Example 7: The computer system according to Example 5 or 6, wherein the cross-over distance (COD) is obtained by subtracting the measured margin distance (MD) from a target lane width.

Example 8: The computer system of any of the preceding Examples, wherein the predetermined distance (PD) is a fixed value.

Example 9: The computer system of any of the preceding Examples, wherein the predetermined distance (PD) is based on a width of at least one of the original lane (5, 7) and the target lane (5, 7).

Example 10: The computer system of any of the preceding Examples, wherein the processing circuitry is further configured to: obtain a change in distance (ΔD) between the host vehicle (1) and a lane line (20a-c) during a lane change from an original lane (5, 7) over the cross-over lane line (20a) to a target lane (5, 7); determine that the change in distance (ΔD) is at least as great as a predetermined change in distance; and cancel the turn indicator (10) based on the change in distance (ΔD) being at least as great as the predetermined change in distance.

Example 11: The computer system of Example 10, wherein the change in distance (ΔD) represents a change of lane line (20a-c) from a left lane line (20a, 20c) of the original lane (5, 7) to a left lane line of the target lane (20a, 20c), or from a right lane line (20a, 20b) of the original lane (5, 7) to a right lane line of the target lane (20a, 20b).

Example 12: The computer system of Example 11, wherein the processing circuitry is further configured to: determine that a distance (COD, MD) between the host vehicle (1) and the left or right lane line (20a-c) is within a tolerance interval based on the obtained change in distance (ΔD).

Example 13: The computer system of Example 1, wherein the cross-over distance (COD) between the host vehicle (1) and the cross-over lane line (20a) is a lateral distance extending in a direction being perpendicular to the longitudinal direction of the cross-over lane line (20a), and wherein the cross-over distance (COD) between the host vehicle (1) and the cross-over lane line (20a) is a distance between a center of the host vehicle (1) and the cross-over lane line (20a), wherein the processing circuitry is further configured to: obtain the cross-over distance (COD) between the host vehicle (1) and the cross-over lane line (20a) by measuring the cross-over distance (COD) between the host vehicle (1) and the cross-over lane line (20a) and/or obtain the cross-over distance (COD) between the host vehicle (1) and the cross-over lane line (20a) by measuring a margin distance (MD) between the host vehicle (1) and a distant lane line (20b, 20c) of the target lane (5, 7), measure the margin distance (MD) between the host vehicle (1) and a distant lane line (20b, 20c) of the target lane (5, 7) as a response to a failed attempt to measure the cross-over distance (COD) between the host vehicle (1) and the cross-over lane line (20a), wherein the cross-over distance (COD) is obtained by subtracting the measured margin distance (MD) from a target lane width, wherein the predetermined distance (PD) is a fixed value or wherein the predetermined value (PD) is based on a width of at least one of the original lane (5, 7) and the target lane (5, 7), wherein the processing circuitry is further configured to: obtain a change in distance (ΔD) between the host vehicle (1) and a lane line (20a-c) during a lane change from an original lane (5, 7) over the cross-over lane line (20a) to a target lane (5, 7); and determine that the change in distance (ΔD) is at least as great as a predetermined change in distance, and cancel the turn indicator (10) based on the change in distance (ΔD) being at least as great as the predetermined change in distance, wherein the change in distance (ΔD) represents a change of lane line (20a-c) from a left lane line (20a, 20c) of the original lane (5, 7) to a left lane line (20a, 20c) of the target lane (5, 7), or from a right lane line (20a, 20b) of the original lane (5, 7) to a right lane line (20a, 20b) of the target lane (5, 7), wherein the processing circuitry is further configured to: determine that a distance (COD, MD) between the vehicle (1) and the left or right lane line (20a-c) is within a tolerance interval based on the obtained change in distance (ΔD), and wherein the processing circuitry is further configured to: re-determine, for a subsequent position of the host vehicle (1) during the lane change, that the distance (COD, MD) between the vehicle (1) and the left or right lane line (20a-c) is within the tolerance interval.

Example 14: A vehicle (1) comprising the computer system of any of Examples 1-13.

Example 15: A computer-implemented method, comprising: determining, by processing circuitry of a computer system, that a turn indicator of a host vehicle is activated; obtaining, by the processing circuitry, a cross-over distance between the host vehicle and a cross-over lane line during a lane change from an original lane over the cross-over lane line to a target lane; determining, by the processing circuitry, that the cross-over distance is at least as great as a predetermined distance, and cancelling, by the processing circuitry, the turn indicator.

Example 16: The method of Example 15, further comprising: obtaining, by the processing circuitry, the cross-over distance between the host vehicle and the cross-over lane line by measuring the cross-over distance between the host vehicle and the cross-over lane line, or by measuring a margin distance between the host vehicle and a distant lane line of the target lane.

Example 17: The method of Example 15 or 16, further comprising measuring the margin distance between the host vehicle and a distant lane line of the target lane as a response to a failed attempt to measure the cross-over distance between the host vehicle and the cross-over lane line.

Example 18: The method of Example 16, wherein the cross-over distance is obtained by subtracting the measured margin distance from a target lane width.

Example 19: A computer program product comprising program code for performing, when executed by the processing circuitry, the method of any of Examples 15 to 18.

Example 20: A non-transitory computer-readable storage medium comprising instructions, which when executed by the processing circuitry, cause the processing circuitry to perform the method of any of Examples 15 to 18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer system comprising processing circuitry configured to:
determine that a turn indicator of a host vehicle is activated;
obtain a cross-over distance between the host vehicle and a cross-over lane line during a lane change from an original lane over the cross-over lane line to a target lane;
determine that the cross-over distance is at least as great as a predetermined distance; and
cancel the turn indicator.

2. The computer system of claim 1, wherein the cross-over distance between the host vehicle and the cross-over lane line is a lateral distance extending in a direction being perpendicular to the longitudinal direction of the cross-over lane line.

3. The computer system of claim 1, wherein the cross-over distance between the host vehicle and the cross-over lane line is a distance between a center of the host vehicle and the cross-over lane line.

4. The computer system of claim 1, wherein the processing circuitry is configured to:
obtain the cross-over distance between the host vehicle and the cross-over lane line by measuring the cross-over distance between the host vehicle and the cross-over lane line.

5. The computer system of claim 1, wherein the processing circuitry is configured to:
obtain the cross-over distance between the host vehicle and the cross-over lane line by measuring a margin distance between the host vehicle and a distant lane line of the target lane.

6. The computer system of claim 5, wherein the processing circuitry is further configured to:
measure the margin distance between the host vehicle and a distant lane line of the target lane as a response to a failed attempt to measure the cross-over distance between the host vehicle and the cross-over lane line.

7. The computer system of claim 5, wherein the cross-over distance is obtained by subtracting the measured margin distance from a target lane width.

8. The computer system of claim 1, wherein the predetermined distance is a fixed value.

9. The computer system of claim 1, wherein the predetermined distance is based on a width of at least one of the original lane and the target lane.

10. The computer system of claim 1, wherein the processing circuitry is further configured to:
obtain a change in distance between the host vehicle and a lane line during a lane change from an original lane over the cross-over lane line to a target lane;
determine that the change in distance is at least as great as a predetermined change in distance; and
cancel the turn indicator based on the change in distance being at least as great as the predetermined change in distance.

11. The computer system of claim 10, wherein the change in distance represents a change of lane line from a left lane line of the original lane to a left lane line of the target lane, or from a right lane line of the original lane to a right lane line of the target lane.

12. The computer system of claim 11, wherein the processing circuitry is further configured to:
determine that a distance between the host vehicle and the left or right lane line is within a tolerance interval based on the obtained change in distance.

13. The computer system of claim 1, wherein:
the cross-over distance between the host vehicle and the cross-over lane line is a lateral distance extending in a direction being perpendicular to the longitudinal direction of the cross-over lane line; and
the cross-over distance between the host vehicle and the cross-over lane line is a distance between a center of the host vehicle and the cross-over lane line; and
the processing circuitry is further configured to:
obtain the cross-over distance between the host vehicle and the cross-over lane line by measuring the cross-over distance between the host vehicle and the cross-over lane line and/or obtain the cross-over distance between the host vehicle and the cross-over lane line by measuring a margin distance between the host vehicle and a distant lane line of the target lane;
measure the margin distance between the host vehicle and a distant lane line of the target lane as a response to a failed attempt to measure the cross-over distance between the host vehicle and the cross-over lane line, wherein the cross-over distance is obtained by subtracting the measured margin distance from a target lane width;
wherein the predetermined distance is a fixed value or wherein the predetermined value is based on a width of at least one of the original lane and the target lane;
obtain a change in distance between the host vehicle and a lane line during a lane change from an original lane over the cross-over lane line to a target lane;
determine that the change in distance is at least as great as a predetermined change in distance;
cancel the turn indicator based on the change in distance being at least as great as the predetermined change in distance, wherein the change in distance represents a change of lane line from a left lane line of the original lane to a left lane line of the target lane, or from a right lane line of the original lane to a right lane line of the target lane;
determine that a distance between the vehicle and the left or right lane line is within a tolerance interval based on the obtained change in distance; and
re-determine, for a subsequent position of the host vehicle during the lane change, that the distance between the vehicle and the left or right lane line is within the tolerance interval.

14. A vehicle comprising the computer system of claim 1.

15. A computer-implemented method, comprising:
determining, by processing circuitry of a computer system, that a turn indicator of a host vehicle is activated;
obtaining, by the processing circuitry, a cross-over distance between the host vehicle and a cross-over lane line during a lane change from an original lane over the cross-over lane line to a target lane;
determining, by the processing circuitry, that the cross-over distance is at least as great as a predetermined distance, and
cancelling, by the processing circuitry, the turn indicator.

16. The method of claim 15, further comprising:
obtaining, by the processing circuitry, the cross-over distance between the host vehicle and the cross-over lane line by measuring the cross-over distance between the host vehicle and the cross-over lane line, or by measuring a margin distance between the host vehicle and a distant lane line of the target lane.

17. The method of claim 15, further comprising measuring the margin distance between the host vehicle and a distant lane line of the target lane as a response to a failed attempt to measure the cross-over distance between the host vehicle and the cross-over lane line.

18. The method of claim 16, wherein the cross-over distance is obtained by subtracting the measured margin distance from a target lane width.

19. A computer program product comprising program code for performing, when executed by the processing circuitry, the method of claim 15.

20. A non-transitory computer-readable storage medium comprising instructions, which when executed by the processing circuitry, cause the processing circuitry to perform the method of claim 15.
